(19) United States
(12) Patent Application Publication
(10) Pub. No.: US 2019/0164355 A1
(43) Pub. Date: May 30, 2019

(54) FEE SETTING SERVER, FEE SETTING METHOD, AND FEE SETTING SYSTEM FOR CAR SHARING FEE

(71) Applicant: TOYOTA JIDOSHA KABUSHIKI KAISHA, Toyota-shi (JP)

(72) Inventors: Akihiko NAKANISHI, Nisshin-shi (JP); Aya ONODERA, Nisshin-shi (JP); Yusuke TSUTSUI, Gifu-ken (JP); Takumi HAMAJIMA, Osaka-shi (JP)

(73) Assignee: TOYOTA JIDOSHA KABUSHIKI KAISHA, Toyota-shi (JP)

(21) Appl. No.: 16/198,423

(22) Filed: Nov. 21, 2018

(30) Foreign Application Priority Data
Nov. 27, 2017 (JP) 2017-226982

(51) Int. Cl. G07B 15/02; G06Q 30/02

(52) U.S. Cl. CPC G07B 15/02; G06Q 30/0283

(57) ABSTRACT

When a fee setting server acquires end-of-utilization information from a vehicle, the fee setting server requests the vehicle to shoot an image serving as in-vehicle image data (information of the number of occupants). When the fee setting server acquires the in-vehicle image data from the vehicle, the fee setting server specifies the number of riding occupants from the acquired in-vehicle image data, and sets the number of occupants. In a case where the set number of occupants is large, the fee setting server sets a utilization fee for car sharing to be lower than that in a case where the number of occupants is small.

This nonprovisional application is based on Japanese Patent Application No. 2017-226982 filed on Nov. 27, 2017 with the Japan Patent Office, the entire contents of which are hereby incorporated by reference.

### BACKGROUND

### Field

The present disclosure relates to setting a car sharing fee.

### Description of the Background Art

Japanese Patent Laying-Open No. 2004-227497 discloses a fee system configured to set a toll to be higher as the number of occupants in a vehicle is smaller. In the fee system in Japanese Patent Laying-Open No. 2004-227497, the number of occupants is detected using a seating sensor provided to the vehicle.

### SUMMARY

In recent years, car sharing allowing a plurality of users to share a single vehicle is increasingly utilized. Car sharing means that a user himself/herself does not own a vehicle and instead obtains membership of a car sharing business operator and utilizes a vehicle owned by the business operator as appropriate.

Car sharing is expected to spread in view of approaches to environmental issues such as reduction of exhaust gas emissions and CO₂ emissions, and relieving congestion by reducing the number of vehicles used (hereinafter also collectively referred to simply as “approaches to environmental issues”). The approaches to environmental issues are further promoted by riding in a vehicle used for car sharing (hereinafter also referred to as a “share car”) with multiple occupants.

Accordingly, there is a demand for a fee setting system for car sharing which promotes riding in a vehicle with multiple occupants and leads to the spread of car sharing.

Although the fee system in Japanese Patent Laying-Open No. 2004-227497 is intended to avoid riding in a vehicle with a single occupant and promote riding with multiple occupants, it is not directed to promoting utilization of car sharing.

The present disclosure has been made to solve the aforementioned problem, and an object thereof is to promote utilization of car sharing while promoting riding in a vehicle with multiple occupants.

A fee setting server in accordance with the present disclosure is a fee setting server configured to set a utilization fee for car sharing. The fee setting server includes: an information acquisition unit configured to acquire information of the number of occupants riding in a vehicle utilized for the car sharing; and a fee setting unit configured to set the utilization fee in a case where the number of occupants specified using the information of the number of occupants at a predetermined time point is large, to be lower than that in a case where the specified number of occupants is small.

According to the above configuration, the fee setting server acquires the information of the number of occupants riding in a share car at the predetermined time point, and in the case where the number of occupants is large, the fee setting server sets the utilization fee to be lower than that in the case where the number of occupants is small. This promotes riding in the share car with multiple occupants, and leads to approaches to environmental issues. In addition, this promotes utilization of car sharing because an advantage in terms of the fee can be obtained.

The predetermined time point is at end of utilization of the vehicle.

According to the above configuration, the number of occupants at the end of utilization of the vehicle is used to set the utilization fee. Since it is generally difficult to determine an end-of-utilization time, the above configuration can suppress a dishonest act of obtaining a multiple occupants discount for the utilization fee by causing others to ride in the vehicle only at a time point when the number of occupants is checked.

When the number of occupants at start of utilization of the vehicle is different from the number of occupants at end of utilization of the vehicle, the fee setting unit sets the utilization fee using the number of occupants at the end of utilization of the vehicle.

Since it is generally easier to determine a start-of-utilization time than the end-of-utilization time, the dishonest act of obtaining the multiple occupants discount for the utilization fee by causing others to ride in the vehicle only at the time point when the number of occupants is checked is more likely to be performed at the start of utilization, than at the end of utilization. According to the above configuration, when the number of occupants at the start of utilization of the vehicle is different from the number of occupants at the end of utilization of the vehicle, the number of occupants at the end of utilization is used to calculate the utilization fee, and thereby the dishonest act as described above can be suppressed.

The vehicle is an electric vehicle.

According to the above configuration, utilization of electric vehicle car sharing (hereinafter also referred to as “EV car sharing”) is promoted. Thereby, a shift from car sharing using a gasoline-powered vehicle or a diesel vehicle to EV car sharing proceeds, and thus the approaches to environmental issues are further promoted.

The information of the number of occupants is a shot image of a state within the vehicle.

According to the above configuration, a vehicle-mounted camera provided in the share car can be utilized effectively. Generally, the vehicle-mounted camera is often provided in the share car for the purpose of crime prevention. By utilizing the vehicle-mounted camera, the present disclosure is applicable without making a new facility investment.

A fee setting method in accordance with another aspect of the present disclosure is a method for setting a utilization fee for car sharing. The fee setting method includes: acquiring information of the number of occupants riding in a vehicle utilized for the car sharing; and setting the utilization fee in a case where the number of occupants specified using the information of the number of occupants at a predetermined time point is large, to be lower than that in a case where the specified number of occupants is small.

A fee setting system in accordance with still another aspect of the present disclosure includes a vehicle utilized for car sharing, and a fee setting server configured to set a utilization fee for the car sharing. The fee setting server is configured to acquire information of the number of occupants riding in the vehicle, and set the utilization fee in a case where the number of occupants specified using the information of the number of occupants at a predetermined time point is large, to be lower than that in a case where the specified number of occupants is small.

The fee setting server acquires the information of the number of occupants from the vehicle.

The fee setting system further includes a communication terminal configured to communicate with the fee setting server. The fee setting server acquires the information of the number of occupants from the communication terminal.

According to the above configuration, the information of the number of occupants can be acquired using the communication terminal of a user, even in a case where the vehicle does not have means for acquiring the information of the number of occupants.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram schematically showing an overall configuration of a fee setting system in accordance with a first embodiment.

FIG. 2 is a diagram showing an example of a detailed configuration for charging a vehicle in accordance with the first embodiment.

FIG. 3 is a functional block diagram showing a configuration of a controller of a fee setting server in accordance with the first embodiment.

FIG. 4 is a diagram showing an example of a configuration of a user list stored in the fee setting server in accordance with the first embodiment.

FIG. 5 is a diagram showing an example of a configuration of a discount application list stored in the fee setting server in accordance with the first embodiment.

FIG. 6 is a flowchart showing processing at the start of utilization of the vehicle performed by the fee setting server and the vehicle in accordance with the first embodiment.

FIG. 7 is a flowchart showing processing at the end of utilization of the vehicle performed by the fee setting server and the vehicle in accordance with the first embodiment.

FIG. 8 is a flowchart showing processing at the start of utilization of a vehicle performed by a fee setting server, a communication terminal, and the vehicle in accordance with a second embodiment.

FIG. 9 is a flowchart showing processing at the end of utilization of the vehicle performed by the fee setting server, the communication terminal, and the vehicle in accordance with the second embodiment.

### DESCRIPTION OF THE PREFERRED EMBODIMENTS

Embodiments of the present disclosure will now be described in detail with reference to the drawings. In the figures, identical or corresponding components are identically denoted and will not be described repeatedly.

### First Embodiment

(As to Overall Configuration of Fee Setting System 1)

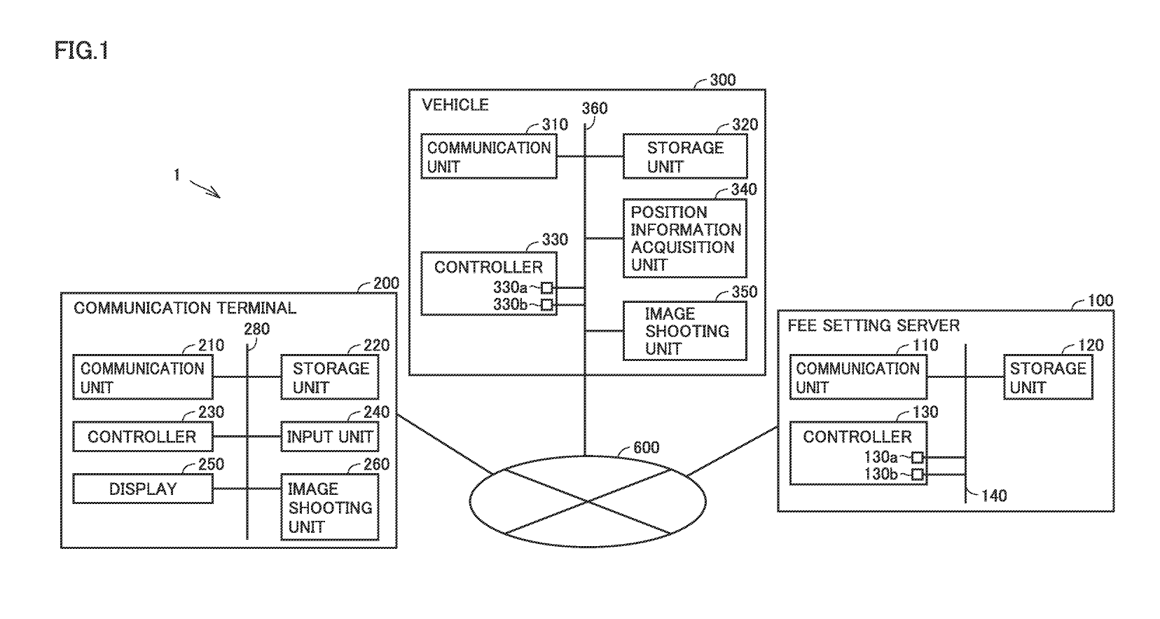

FIG. 1 is a diagram schematically showing an overall configuration of a fee setting system 1 in accordance with a first embodiment.

As shown in FIG. 1, fee setting system 1 in accordance with the first embodiment includes a fee setting server 100, a communication terminal 200, and a vehicle 300 which is an electric vehicle. It should be noted that, although the first embodiment will describe an example where vehicle 300 is an electric vehicle, vehicle 300 may be a hybrid vehicle, a plug-in hybrid vehicle, a gasoline-powered vehicle, a diesel vehicle, or the like.

Communication terminal 200 is a communication terminal used by a user of fee setting system 1, and is, for example, a smartphone, a notebook personal computer, or the like. Using communication terminal 200, the user performs membership registration for EV car sharing using fee setting system 1, and reserves a vehicle for EV car sharing.

Fee setting server 100 includes a communication unit 110, a storage unit 120, and a controller 130. Each component is communicatively connected by a communication bus 140.

Communication unit 110 is configured to allow communications with a communication unit 210 of communication terminal 200, a communication unit 310 of vehicle 300, for example. Communications between communication unit 110 and communication units 210 and 310 are performed via a communication network 600 such as the Internet or a telephone line.

Storage unit 120 includes, for example, a large-capacity storage device such as a hard disk drive or a solid state drive. Storage unit 120 stores information of users who have made membership registration for EV car sharing, information of share cars, and the like. Further, storage unit 120 stores a user list 500 in which information about utilization of EV car sharing for each user is registered. Storage unit 120 also stores a discount application list 700 created beforehand. Details of user list 500 and discount application list 700 will be described later.

Controller 130 includes a CPU (Central Processing Unit) 130a, a memory (ROM and RAM) 130b, input/output ports (not shown) for inputting/outputting various signals, and the like. Controller 130 is configured to execute predetermined computation processing based on information stored in storage unit 120, and information received from communication terminal 200 and vehicle 300 via communication unit 110. Further, as described later, controller 130 transmits an image shooting request requesting to shoot an image of an occupant(s) within the vehicle, to either one of communication terminal 200 and vehicle 300. Details of controller 130 will be described later.

It should be noted that the first embodiment will describe an example where controller 130 transmits the image shooting request to vehicle 300.

Communication terminal 200 includes communication unit 210, a storage unit 220, a controller 230, an input unit 240, a display 250, and an image shooting unit 260. Each component is communicatively connected by a communication bus 280.

Communication unit 210 is configured to allow communication with communication unit 110 of fee setting server 100. Communication between communication unit 210 and communication unit 110 is performed via communication network 600.

Storage unit 220 includes, for example, a large-capacity storage device such as a flash memory, a hard disk drive, or a solid state drive.

Controller 230 is configured to execute predetermined processing based on information stored in storage unit 220, and information received from fee setting server 100 via communication unit 210, for example.

Input unit 240 is an input interface in communication terminal 200. Input unit 240 is composed of a keyboard, a mouse, a touch panel, and the like, and accepts input operations done via the keyboard, the mouse, the touch panel, and the like.

Display 250 is controlled by controller 230 to display an image. Display 250 is implemented for example as a liquid crystal panel or the like.

Image shooting unit 260 is a camera for acquiring a shot image. Specifically, image shooting unit 260 has an optical lens, an image sensor, and the like.

Vehicle 300 includes communication unit 310, a storage unit 320, a controller 330, a position information acquisition unit 340, and an image shooting unit 350. Each component is communicatively connected by a communication bus 360.

Communication unit 310 is configured to allow communication with communication unit 110 of fee setting server 100. Communication between communication unit 310 and communication unit 110 is performed via communication network 600.

Storage unit 320 includes, for example, a nonvolatile memory, a hard disk drive, a solid state drive, or the like. Storage unit 320 stores, for example, information about the position of vehicle 300, and the like.

Controller 330 includes, for example, a CPU 330a, a memory (ROM and RAM) 330b, input/output ports for inputting/outputting various signals (not shown), and the like. Controller 330 is configured to execute predetermined computation processing based on information stored in storage unit 320. In the first embodiment, when controller 330 acquires the image shooting request from fee setting server 100, controller 330 transmits, to image shooting unit 350, an image shooting instruction to shoot the image of the occupant(s) within the vehicle.

In addition, for example when vehicle 300 shifts from a READY-OFF state to a READY-ON state, controller 330 transmits, to fee setting server 100 via communication unit 310, vehicle information for specifying vehicle 300, together with start-of-utilization information notifying that utilization of vehicle 300 starts. When vehicle 300 shifts from the READY-ON state to the READY-OFF state, controller 330 transmits, to fee setting server 100, end-of-utilization information notifying that utilization of vehicle 300 ends. It should be noted that the READY-ON state refers to a state in which the vehicle is capable of traveling, and the READY-OFF state refers to a state in which the vehicle is incapable of traveling.

Further, in EV car sharing in which the start and end of utilization of the vehicle are detected based on insertion/removal of a card key into/from vehicle 300, the start-of-utilization information and the end-of-utilization information may be transmitted to fee setting server 100 based on insertion/removal of the card key into/from vehicle 300. When the card key is inserted into vehicle 300, controller 330 transmits the start-of-utilization information and the vehicle information to fee setting server 100 via communication unit 310. When an operation of removing the card key from vehicle 300 is performed, controller 330 transmits the end-of-utilization information to fee setting server 100 via communication unit 310.

Position information acquisition unit 340 is configured to acquire a current position of vehicle 300. For example, position information acquisition unit 340 uses a GPS (Global Positioning System) to acquire the current position of vehicle 300. Position information acquisition unit 340 transmits to controller 330 position information indicating the acquired current position of vehicle 300.

Image shooting unit 350 is a camera for acquiring a shot image. Specifically, image shooting unit 350 has an optical lens, an image sensor, and the like. In the first embodiment, when image shooting unit 350 receives the image shooting instruction from controller 330, image shooting unit 350 shoots the image of the occupant(s) within the vehicle, and outputs image data acquired by image shooting (hereinafter also referred to as “in-vehicle image data”) to controller 330.

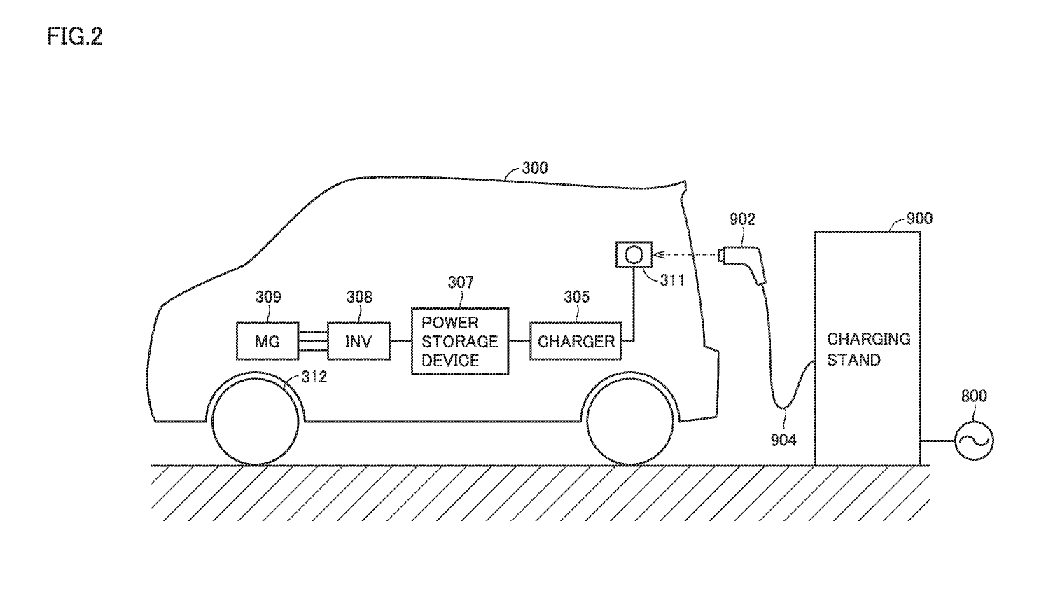

FIG. 2 is a diagram showing an example of a detailed configuration for charging the vehicle in accordance with the first embodiment. FIG. 2 does not show communication unit 310, controller 330, and the like shown in FIG. 1.

As shown in FIG. 2, vehicle 300 further includes a charger 305, a power storage device 307, an inverter 308, a motor generator 309, and an inlet 311.

When a charging connector 902 of a charging stand 900 is connected to inlet 311, charger 305 charges power storage device 307 with power supplied from an external power source 800.

Power storage device 307 is configured using a secondary battery such as a nickel metal hydride battery or a lithium ion battery, for example. Power storage device 307 may be any power storage device capable of storing power, and for example, a large-capacity capacitor may be used instead of a secondary battery.

Inverter 308 is a power conversion device which converts power between AC power and DC power. For example, inverter 308 converts DC power of power storage device 307 into AC power and supplies it to motor generator 309. Further, for example, inverter 308 converts AC power (regenerative power) from motor generator 309 into DC power, and supplies it to power storage device 307 to charge power storage device 307.

Motor generator 309 receives power supplied from inverter 308 and provides rotational force to drive wheels 312. Drive wheels 312 are rotated by the rotational force provided by motor generator 309 to drive vehicle 300.

Inlet 311 is provided to an exterior portion of vehicle 300 together with a cover (not shown) such as a lid. Inlet 311 has a shape allowing charging connector 902 to be connected thereto. Inlet 311 and charging connector 902 both have contacts, respectively, built therein, and when charging connector 902 is connected to inlet 311, the contacts come into contact with each other, and inlet 311 and charging connector 902 are thus electrically connected.

Charging stand 900 is installed outside vehicle 300 and connected to charging connector 902 via a charging cable 904. Charging stand 900 is electrically connected to power source 800, and when charging connector 902 is connected to inlet 311, the power of power source 800 is supplied via charging stand 900, charging cable 904, and charging connector 902 to vehicle 300.

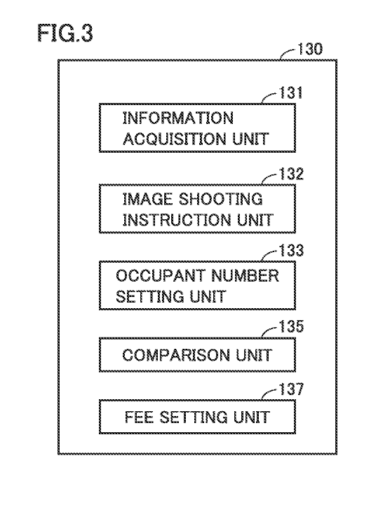

FIG. 3 is a functional block diagram showing a configuration of controller 130 of fee setting server 100 in accordance with the first embodiment. Controller 130 includes an information acquisition unit 131, an image shooting instruction unit 132, an occupant number setting unit 133, a comparison unit 135, and a fee setting unit 137.

Information acquisition unit 131 acquires, from vehicle 300 via communication unit 110, the start-of-utilization information, the end-of-utilization information, the vehicle information, the position information, the in-vehicle image data, and the like. Further, information acquisition unit 131 acquires the in-vehicle image data and the like from communication terminal 200, via communication unit 110.

Image shooting instruction unit 132 transmits, to communication terminal 200 or vehicle 300, the image shooting request requesting to shoot the image of the occupant(s) within the vehicle. For example, when the start-of-utilization information and the end-of-utilization information are acquired from vehicle 300, image shooting instruction unit 132 transmits the image shooting request to communication terminal 200 or vehicle 300. It should be noted that image shooting instruction unit 132 transmits the image shooting request to at least one of communication terminal 200 and vehicle 300.

It should be noted that timing for transmitting the image shooting request may be set using the position information of vehicle 300. For example, when vehicle 300 shifts from the READY-OFF state to the READY-ON state, position information acquisition unit 340 of the vehicle acquires the position information of vehicle 300, and transmits it to fee setting server 100. The image shooting request may be transmitted when a position indicated by the transmitted position information is a location where vehicle 300 is rented. Further, the image shooting request may be transmitted when vehicle 300 is in the READY-ON state and a position indicated by the position information of vehicle 300 acquired periodically is a location where vehicle 300 is to be returned.

Occupant number setting unit 133 specifies the number of occupants riding in the vehicle, based on the in-vehicle image data acquired by information acquisition unit 131 from communication terminal 200, or based on the in-vehicle image data acquired by information acquisition unit 131 from vehicle 300, and sets it as the number of occupants. As a method for specifying the number of occupants from the image data, any well-known technique such as face detection means may be used, and the detailed description thereof will not be given. It should be noted that, although an example where fee setting server 100 specifies the number of occupants from the image data is described in the description of the overall configuration of fee setting system 1, communication terminal 200 or vehicle 300 may specify the number of occupants. In that case, occupant number setting unit 133 acquires the specified number of occupants from communication terminal 200 or vehicle 300, and sets the number of occupants. It should be noted that the in-vehicle image data corresponds to the “information of the number of occupants” in the present disclosure.

Comparison unit 135 compares the number of occupants set by occupant number setting unit 133 at the start of utilization of vehicle 300 with the number of occupants set by occupant number setting unit 133 at the end of utilization of vehicle 300.

Fee setting unit 137 sets a utilization fee for EV car sharing to be billed to the user who utilizes vehicle 300, according to a result of comparison by comparison unit 135, and the like. Details of setting the utilization fee will be described later.

(As to EV Car Sharing)

In recent years, car sharing is increasingly utilized in view of approaches to environmental issues. Especially, as electric vehicles are increasingly used, EV car sharing, which can further promote the approaches to environmental issues, is expected to spread.

Furthermore, the approaches to environmental issues are further accelerated by riding in a share car with multiple occupants.

Accordingly, there is a demand for a fee setting system for EV car sharing which promotes riding in a share car with multiple occupants and leads to the spread of EV car sharing. However, such a fee setting system has not been provided.

In the first embodiment, fee setting server 100 acquires in-vehicle image data (information of the number of occupants) from vehicle 300. Then, fee setting server 100 specifies the number of riding occupants from the acquired in-vehicle image data, and sets it as the number of occupants. In a case where the set number of occupants is large, fee setting server 100 sets the utilization fee to be lower than that in a case where the number of occupants is small.

Thus, the fee setting server specifies the number of occupants riding in a share car, and in the case where the number of occupants is large, the fee setting server sets the utilization fee for EV car sharing to be lower than that in the case where the number of occupants is small. This promotes riding in the share car with multiple occupants, and leads to approaches to environmental issues. In addition, this promotes utilization of EV car sharing because an advantage in terms of the fee can be obtained.

It should be noted that, in the first embodiment, communication terminal 200 does not have to be used. An example where fee setting server 100 acquires in-vehicle image data (information of the number of occupants) from communication terminal 200 will be described in the second embodiment.

(As to User List)

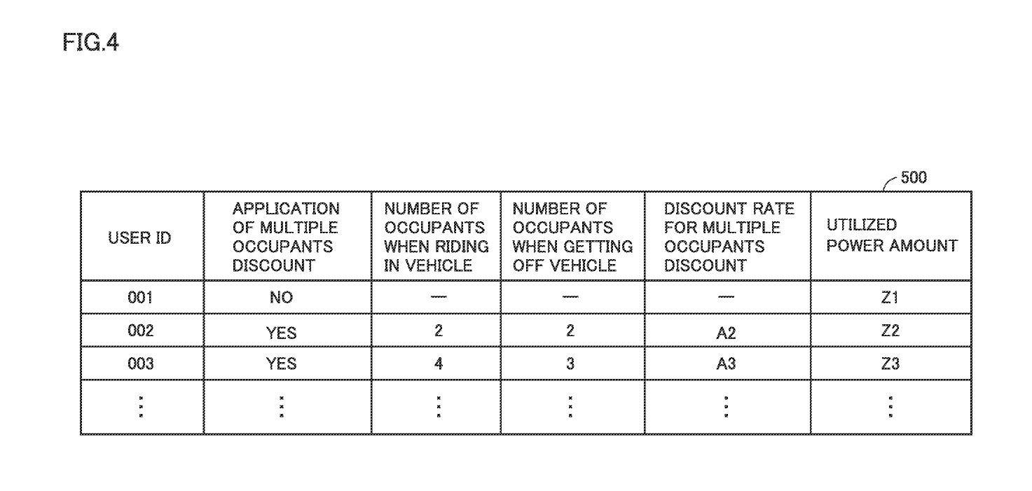

FIG. 4 is a diagram showing an example of a configuration of user list 500 stored in fee setting server 100 in accordance with the first embodiment. As shown in FIG. 4, in the user list 500, items “application of multiple occupants discount”, “number of occupants when riding in vehicle”, “number of occupants when getting off vehicle”, “discount rate for multiple occupants discount”, and “utilized power amount” are registered for each user specified by an item “user ID”. It should be noted that user list 500 is stored in storage unit 120.

The “user ID” is set for a user when utilization registration for EV car sharing is completed, and is used to specify the user.

In the “application of multiple occupants discount”, it is registered whether or not the user desires application of a multiple occupants discount, which discounts the utilization fee by utilization of a share car with multiple occupants, at the start of utilization of EV car sharing. When the user does not desire application of the multiple occupants discount, “NO” is registered, and when the user desires application of the multiple occupants discount, “YES” is registered.

In the “number of occupants when riding in vehicle”, the number of occupants specified by fee setting server 100 using in-vehicle image data acquired by image shooting at the start of utilization of vehicle 300 is registered.

In the “number of occupants when getting off vehicle”, the number of occupants specified by fee setting server 100 using in-vehicle image data acquired by image shooting at the end of utilization of vehicle 300 is registered.

In the “discount rate for multiple occupants discount”, a discount rate for the multiple occupants discount set by checking the number of occupants set according to a method described later against discount application list 700 described later is registered.

In the “utilized power amount”, a power amount utilized by the user through EV car sharing using vehicle 300 is registered. By multiplying the power amount by a power unit price to which the discount rate for the multiple occupants discount is applied, a utilization fee for current utilization of vehicle 300 is set.

Since a user having a user ID 001 does not desire application of the multiple occupants discount, the number of occupants when riding in the vehicle, the number of occupants when getting off the vehicle, and the discount rate for the multiple occupants discount are not registered, and only the utilized power amount is registered.

A user having a user ID 002 desires application of the multiple occupants discount, and the number of occupants when riding in the vehicle is registered as 2, and the number of occupants when getting off the vehicle is registered as 2. Thus, the number of occupants is set to 2 by fee setting server 100 according to the method described later, and is checked against discount application list 700 described later. Then, the discount rate for the multiple occupants discount is set to A2.

A user having a user ID 003 desires application of the multiple occupants discount, and the number of occupants when riding in the vehicle is registered as 4, and the number of occupants when getting off the vehicle is registered as 3. Thus, the number of occupants is set to 3 by fee setting server 100 according to the method described later, and is checked against discount application list 700 described later. Then, the discount rate for the multiple occupants discount is set to A3.

(Discount Application List 700)

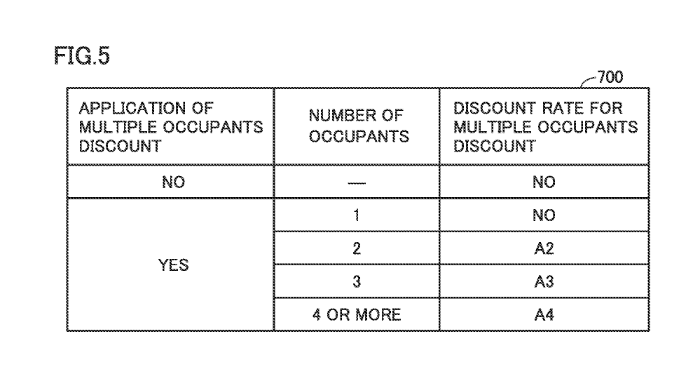

FIG. 5 is a diagram showing an example of a configuration of discount application list 700 stored in fee setting server 100 in accordance with the first embodiment. Discount application list 700 is a list for setting the discount rate for the multiple occupants discount. Specifically, fee setting server 100 sets the discount rate for the multiple occupants discount by checking an acquired desire for application of the multiple occupants discount and the set number of occupants against discount application list 700. It should be noted that discount application list 700 is stored in storage unit 120.

As shown in FIG. 5, in the first embodiment, items “application of multiple occupants discount”, “number of occupants”, and “discount rate for multiple occupants discount” are set in discount application list 700. Fee setting server 100 checks application of the multiple occupants discount and the set number of occupants against discount application list 700, and sets the discount rate for the multiple occupants discount.

When a user does not desire application of the multiple occupants discount (“NO” in “application of multiple occupants discount”), application of the multiple occupants discount is not set.

When a user desires application of the multiple occupants discount (“YES” in “application of multiple occupants discount”), different discount rates for the multiple occupants discount are set depending on the number of occupants. The discount rates for the multiple occupants discount are set to be increased in order of discount rate A2, discount rate A3, and a discount rate A4 (A2<A3<A4).

When the number of occupants is 1, application of the multiple occupants discount is not set. When the number of occupants is 2, discount rate A2 is set as the discount rate for the multiple occupants discount. When the number of occupants is 3, discount rate A3 is set as the discount rate for the multiple occupants discount. When the number of occupants is 4 or more, discount rate A4 is set as the discount rate for the multiple occupants discount. It should be noted that, although the first embodiment describes a case where discount rate A4 is uniformly set when the number of occupants is 4 or more, different discount rates may be set depending on the number of occupants also when the number of occupants is 4 or more.

(As to Method for Setting Utilization Fee)

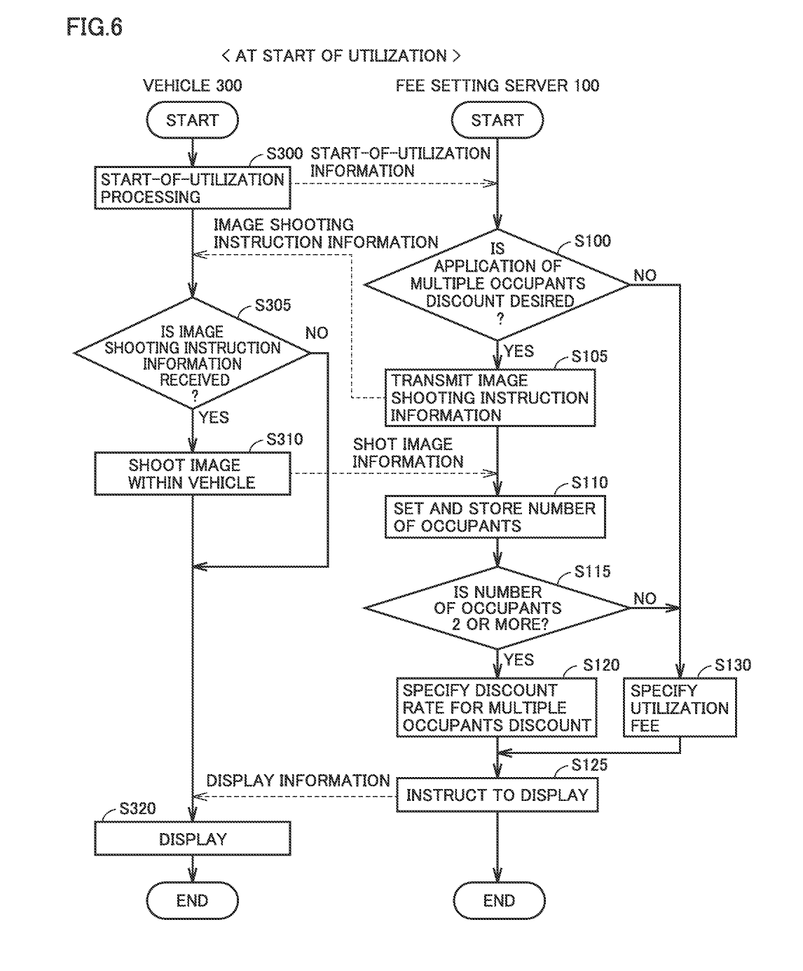

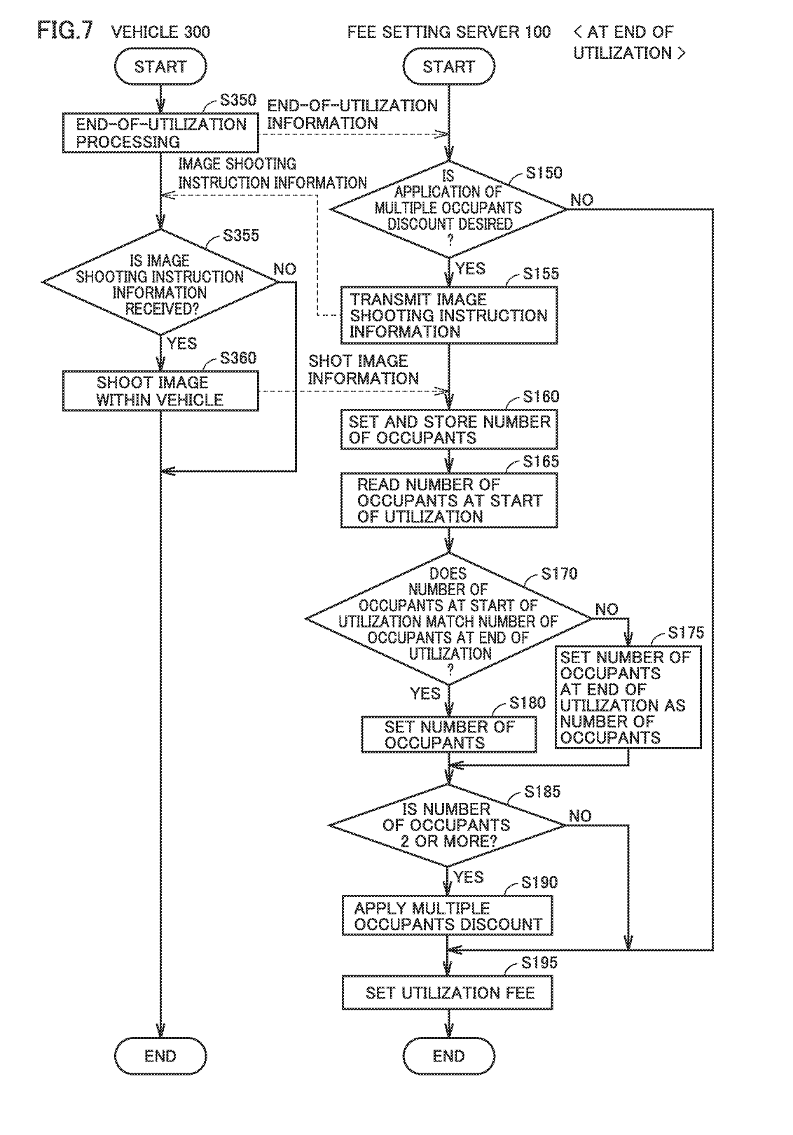

FIG. 6 is a flowchart showing processing at the start of utilization of vehicle 300 performed by fee setting server 100 and vehicle 300 in accordance with the first embodiment. This processing is performed each time a user starts utilization of EV car sharing in fee setting system 1. It should be noted that, although each step in the flowchart shown in FIG. 6 is implemented by software processing performed by fee setting server 100 and vehicle 300, a part thereof may be implemented by hardware (electric circuitry) fabricated within fee setting server 100 and vehicle 300. The same applies to each step shown in the flowchart shown in FIG. 7.

When start-of-utilization processing is performed, vehicle 300 transmits start-of-utilization information to fee setting server 100 (step 300; hereinafter each step will be abbreviated as “S”). It should be noted that the start-of-utilization processing is, for example, that vehicle 300 shifts from the READY-OFF state to the READY-ON state. In EV car sharing in which the start and end of utilization of the vehicle are detected based on insertion/removal of the card key into/from vehicle 300, the start-of-utilization processing may be insertion of the card key into vehicle 300.

When fee setting server 100 acquires the start-of-utilization information, fee setting server 100 determines whether or not application of the multiple occupants discount is desired (S100). In the first embodiment, when the user reserves vehicle 300 through communication terminal 200, whether or not the user desires application of the multiple occupants discount is input, and is registered in user list 500.

When fee setting server 100 determines that application of the multiple occupants discount is not desired (NO in S100), fee setting server 100 reads discount application list 700 from storage unit 120, checks the determined result against discount application list 700, and specifies a standard fee of the utilization fee for EV car sharing (to which the multiple occupants discount is not applied), as the utilization fee (S130). Then, fee setting server 100 transmits, to vehicle 300, display information for causing vehicle 300 to display the specified standard fee (S125).

When fee setting server 100 determines that application of the multiple occupants discount is desired (YES in S100), fee setting server 100 transmits, to vehicle 300, image shooting instruction information instructing to shoot an image of an occupant(s) within the vehicle (an image shooting request) (S105).

When vehicle 300 receives the image shooting instruction information from fee setting server 100 (YES in S305), vehicle 300 shoots an image within the vehicle, and transmits, to fee setting server 100, shot image information which is a shot image of the occupant(s) within the vehicle (in-vehicle image data) (S310). When vehicle 300 does not receive the image shooting instruction information within a certain period of time (NO in S305), vehicle 300 waits until it acquires the display information from fee setting server 100, and upon acquiring the display information, vehicle 300 performs processing in S320 described later.

When fee setting server 100 acquires the shot image information from vehicle 300, fee setting server 100 specifies the number of occupants when riding in vehicle 300 (at the start of utilization of vehicle 300) using the shot image information, sets it as the number of occupants when riding in the vehicle, and stores it in user list 500 (S110). Fee setting server 100 determines whether or not the set number of occupants when riding in the vehicle is 2 or more (S115). When fee setting server 100 determines that the number of occupants when riding in the vehicle is less than 2, that is, 1 (NO in S115), fee setting server 100 reads discount application list 700 from storage unit 120, checks the determined result against discount application list 700, and specifies the standard fee as the utilization fee (S130). Then, fee setting server 100 transmits, to vehicle 300, the display information for causing vehicle 300 to display the specified utilization fee (S125).

When fee setting server 100 determines that the set number of occupants when riding in the vehicle is 2 or more (YES in S115), fee setting server 100 reads discount application list 700 from storage unit 120, checks the determined result against discount application list 700, and specifies a discount rate for the multiple occupants discount depending on the number of occupants when riding in the vehicle (S120). Then, fee setting server 100 transmits, to vehicle 300, the display information for causing vehicle 300 to display the specified discount rate (S125). Fee setting server 100 causes vehicle 300 to display the specified discount rate in order to notify the user of the specified discount rate as a measure of the utilization fee at the start of utilization. From the display, the user can recognize the measure of the utilization fee at the start of utilization of vehicle 300. It should be noted that the specified discount rate and the standard fee may be displayed, or a fee to which the specified discount rate is applied may be displayed.

When vehicle 300 receives the display information from fee setting server 100, vehicle 300 displays the discount rate specified at the start of utilization as the measure (S320). It should be noted that the discount rate may be displayed by a navigation device mounted in vehicle 300, or a display device separately provided, for example.

FIG. 7 is a flowchart showing processing at the end of utilization of vehicle 300 performed by fee setting server 100 and vehicle 300 in accordance with the first embodiment. This processing is performed each time the user ends utilization of EV car sharing in fee setting system 1.

When end-of-utilization processing is performed, vehicle 300 transmits end-of-utilization information to fee setting server 100 (S350). It should be noted that the end-of-utilization processing is, for example, that the user performs an operation of ending utilization through the navigation device mounted in vehicle 300, that the user performs an operation of ending utilization through the display device separately provided to vehicle 300, or the like. For example, in the case where the user operates the navigation device, the user may operate it voluntarily, or fee setting server 100 may cause the navigation device to display an end-of-utilization button when vehicle 300 comes close to a set location where vehicle 300 is to be returned, using the position information of vehicle 300 acquired from vehicle 300. Further, in EV car sharing in which the start and end of utilization of the vehicle are detected based on insertion/removal of the card key into/from vehicle 300, the end-of-utilization processing may be an operation of removing the card key from vehicle 300.

When fee setting server 100 acquires the end-of-utilization information, fee setting server 100 refers to user list 500, and determines whether or not application of the multiple occupants discount is desired (S150).

When fee setting server 100 determines that application of the multiple occupants discount is not desired (NO in S150), fee setting server 100 reads discount application list 700 from storage unit 120, checks the determined result against discount application list 700, and sets the standard fee of the utilization fee for EV car sharing as the utilization fee (S195).

When fee setting server 100 determines that application of the multiple occupants discount is desired (YES in S150), fee setting server 100 transmits, to vehicle 300, image shooting instruction information instructing to shoot an image of the occupant(s) within the vehicle (an image shooting request) (S155).

When vehicle 300 receives the image shooting instruction information from fee setting server 100 (YES in S355), vehicle 300 shoots an image within the vehicle, and transmits, to fee setting server 100, shot image information which is a shot image of the occupant(s) within the vehicle (S360). When vehicle 300 does not receive the image shooting instruction information within a certain period of time (NO in S355), vehicle 300 terminates the processing.

When fee setting server 100 acquires the shot image information from vehicle 300, fee setting server 100 specifies the number of occupants when getting off vehicle 300 (at the end of utilization of vehicle 300) using the shot image information, sets it as the number of occupants when getting off the vehicle, and stores it in user list 500 (S160). Fee setting server 100 refers to user list 500, and reads the number of occupants at the end of utilization (S165).

Fee setting server 100 determines whether the number of occupants at the start of utilization (the number of occupants when riding in the vehicle) matches the number of occupants at the end of utilization (the number of occupants when getting off the vehicle) (S170). When the number of occupants at the start of utilization does not match the number of occupants at the end of utilization (NO in S170), fee setting server 100 sets the number of occupants at the end of utilization as the number of occupants in vehicle 300 (S175). When the number of occupants at the start of utilization matches the number of occupants at the end of utilization (YES in S170), fee setting server 100 sets the matching number of occupants as the number of occupants in vehicle 300 (S180).

Fee setting server 100 determines whether or not the set number of occupants is 2 or more (S185). When fee setting server 100 determines that the number of occupants is less than 2, that is, 1 (NO in S185), fee setting server 100 reads discount application list 700 from storage unit 120, checks the determined result against discount application list 700, and sets the standard fee as the utilization fee (S195).

When fee setting server 100 determines that the set number of occupants is 2 or more (YES in S185), fee setting server 100 reads discount application list 700 from storage unit 120, checks the determined result against discount application list 700, and specifies a discount rate for the multiple occupants discount depending on the number of occupants (S190). Then, fee setting server 100 sets the utilization fee by applying the specified discount rate (S195).

As described above, in the first embodiment, fee setting server 100 acquires in-vehicle image data (information of the number of occupants), which is shot image information, from vehicle 300. Then, fee setting server 100 specifies the number of riding occupants from the acquired in-vehicle image data, and sets the number of occupants. In a case where the set number of occupants is large, fee setting server 100 sets the utilization fee to be lower than that in a case where the number of occupants is small.

Thus, fee setting server 100 specifies the number of occupants riding in a share car and sets it as the number of occupants, and in the case where the number of occupants is large, fee setting server 100 sets the utilization fee for car sharing to be lower than that in the case where the number of occupants is small. This promotes riding in the share car with multiple occupants, and leads to approaches to environmental issues. In addition, this promotes utilization of car sharing because an advantage in terms of the fee can be obtained.

Further, fee setting server 100 sets the number of occupants when riding in the vehicle at the start of utilization, and causes vehicle 300 at the start of utilization to display the discount rate to be applied in a case where the number of occupants when riding in the vehicle is set as the number of occupants in vehicle 300.

Thereby, the user can recognize the measure of the utilization fee at the start of utilization of vehicle 300.

Further, fee setting server 100 sets the utilization fee using the number of occupants at the end of utilization of vehicle 300 (the number of occupants when getting off the vehicle).

Thereby, the number of occupants at the end of utilization of the vehicle is used to set the utilization fee. Since it is generally difficult to determine an end-of-utilization time, the above configuration can suppress a dishonest act of obtaining the multiple occupants discount for the utilization fee by causing others to ride in the vehicle only at a time point when the number of occupants is checked.

Further, when the number of occupants at the start of utilization of vehicle 300 (the number of occupants when riding in the vehicle) is different from the number of occupants at the end of utilization of vehicle 300 (the number of occupants when getting off the vehicle), fee setting server 100 sets the utilization fee using the number of occupants at the end of utilization of vehicle 300.

Since it is generally easier to determine a start-of-utilization time than the end-of-utilization time, the dishonest act of obtaining the multiple occupants discount for the utilization fee by causing others to ride in the vehicle only at the time point when the number of occupants is checked is more likely to be performed at the start of utilization, than at the end of utilization. Accordingly, when the number of occupants at the start of utilization of the vehicle is different from the number of occupants at the end of utilization of the vehicle, the number of occupants at the end of utilization is used to calculate the utilization fee, and thereby the dishonest act as described above can be suppressed.

Further, an example where vehicle 300 is an electric vehicle has been described.

As utilization of EV car sharing is promoted, a shift from car sharing using a gasoline-powered vehicle or a diesel vehicle to EV car sharing proceeds, and the approaches to environmental issues are further promoted.

Further, fee setting server 100 sets the number of occupants in vehicle 300 using in-vehicle image data.

Thereby, a vehicle-mounted camera provided in the share car can be utilized effectively. Generally, the vehicle-mounted camera is often provided in the share car for the purpose of crime prevention. By utilizing the vehicle-mounted camera, the present disclosure is applicable without making a new facility investment.

It should be noted that, although fee setting server 100 sets the utilization fee using the number of occupants at the start of utilization of vehicle 300 and the number of occupants at the end of utilization of vehicle 300 in the first embodiment, fee setting server 100 may set the utilization fee using only one of them.

In this case, it is only necessary to perform processing of shooting the image of the occupant(s) and setting the number of occupants either at the start or at the end of utilization of vehicle 300, and thus the processing can be simplified.

Further, although fee setting system 1 shoots the image of the occupant(s) within the vehicle at the start of utilization and at the end of utilization in the first embodiment, timing for shooting the image of the occupant(s) within the vehicle is not limited to at the start of utilization and at the end of utilization. For example, it may be arbitrary timing during utilization of vehicle 300.

Shooting the image of the occupant(s) within the vehicle at the arbitrary timing during utilization of vehicle 300 can suppress the dishonest act of obtaining the multiple occupants discount for the utilization fee by causing others to ride in the vehicle only at the time of shooting the image within the vehicle. It should be noted that various setting methods are applicable to set the arbitrary timing for shooting the image of the occupant(s) within the vehicle. For example, the arbitrary timing may be set to a time point when a predetermined time set beforehand has passed since the start of utilization of vehicle 300, or a time point when vehicle 300 has traveled for a predetermined traveling distance set beforehand since the start of utilization of vehicle 300.

Further, the first embodiment has described an example where, in the case where the user desires application of the multiple occupants discount, the multiple occupants discount is applied when the number of occupants is 2 or more. However, the number of occupants to which the multiple occupants discount is applied is not limited to 2 or more, and any number of occupants may be set. For example, the number of occupants to which the multiple occupants discount is applied may be 3 or more, or 4 or more.

Further, the first embodiment has described an example where, in the case where the multiple occupants discount is applied, the discount rate for the multiple occupants discount is set depending on the number of occupants. However, it is only necessary that any discount is applied. For example, there may be applied a multiple occupants discount in which, if the number of occupants is more than or equal to a certain number, a uniform discount rate is set regardless of the number of occupants.

Further, fee setting server 100 in the first embodiment specifies the number of riding occupants using the in-vehicle image data which is the shot image of the occupant(s) within the vehicle, and sets the number of occupants. However, vehicle 300 may specify the number of riding occupants. In this case, fee setting server 100 acquires the number of riding occupants specified by vehicle 300, and sets the number of occupants.

Further, although the in-vehicle image data which is the shot image of the occupant(s) within the vehicle is used as means for specifying the number of occupants in the first embodiment, it is only necessary that the number of occupants can be specified. For example, the number of occupants may be specified using a seating sensor provided to each seat of vehicle 300, the user may input the number of occupants to the navigation device, or an operator may check the number of occupants using a vehicle-mounted camera or voice.

### Second Embodiment

The first embodiment has described an example where fee setting server 100 acquires in-vehicle image data from vehicle 300. Fee setting server 100 may acquire in-vehicle image data from communication terminal 200. In the following, an example where fee setting server 100 acquires in-vehicle image data from communication terminal 200 will be described.

It should be noted that the second embodiment will describe an example where the number of occupants at the end of utilization (the number of occupants when getting off the vehicle) is used to set the discount rate for the multiple occupants discount. The number of occupants at the start of utilization (the number of occupants when riding in the vehicle) is used to display a measure of the utilization fee at the start of utilization of vehicle 300. Also in the second embodiment, the discount rate for the multiple occupants discount may be set using the number of occupants at the start of utilization and the number of occupants at the end of utilization, as in the first embodiment. In the second embodiment, controller 130 of fee setting server 100 transmits the image shooting request to communication terminal 200. Moreover, when controller 230 of communication terminal 200 acquires, from fee setting server 100, the image shooting request requesting to shoot the image of the occupant(s) within the vehicle, controller 230 causes display 250 to display that fact, and urges the user to shoot an image of a state within the vehicle. Furthermore, image shooting unit 260 outputs image data acquired by image shooting in response to the image shooting request to controller 230.

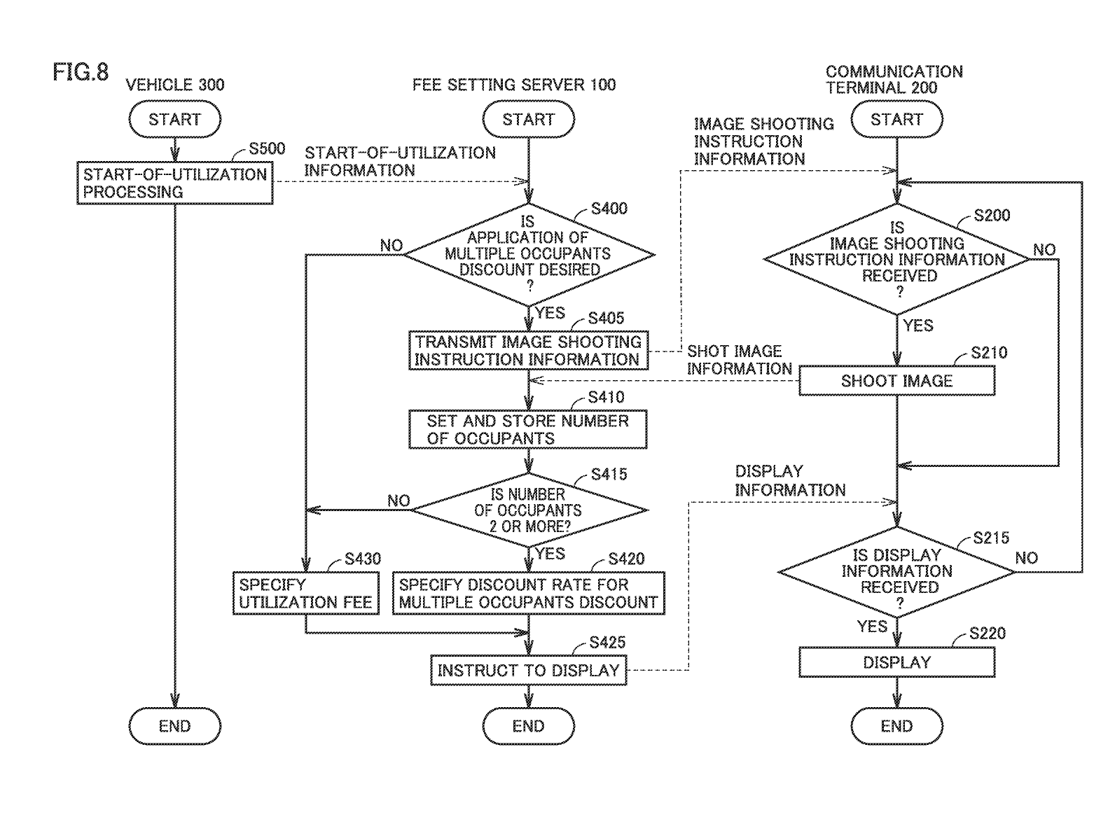

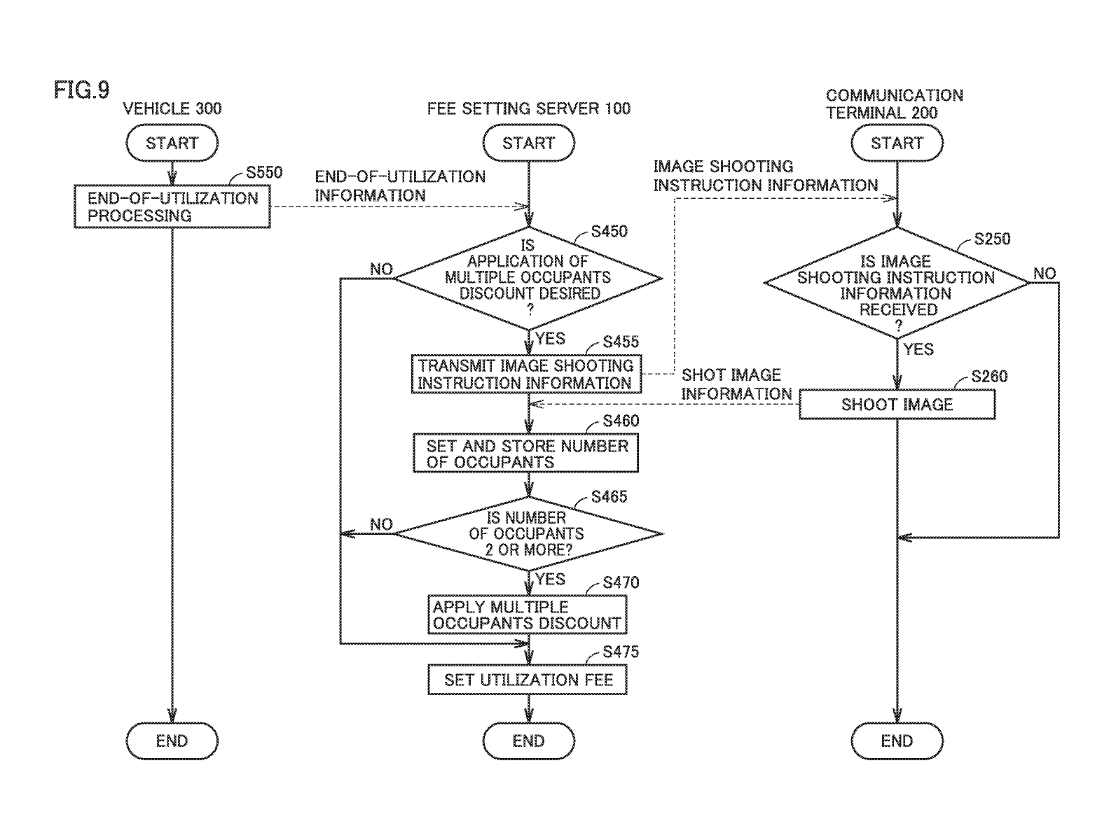

FIG. 8 is a flowchart showing processing at the start of utilization of vehicle 300 performed by fee setting server 100, communication terminal 200, and vehicle 300 in accordance with the second embodiment. This processing is performed each time a user starts utilization of EV car sharing in fee setting system 1. It should be noted that, although each step in the flowchart shown in FIG. 8 is implemented by software processing performed by fee setting server 100, communication terminal 200, and vehicle 300, a part thereof may be implemented by hardware (electric circuitry) fabricated within fee setting server 100, communication terminal 200, and vehicle 300. The same applies to each step in the flowchart shown in FIG. 9.

When start-of-utilization processing is performed, vehicle 300 transmits start-of-utilization information to fee setting server 100 (S500).

When fee setting server 100 acquires the start-of-utilization information, fee setting server 100 determines whether or not application of the multiple occupants discount is desired (S400).

When fee setting server 100 determines that application of the multiple occupants discount is not desired (NO in S400), fee setting server 100 reads discount application list 700 from storage unit 120. Fee setting server 100 checks the determined result against discount application list 700, and specifies the standard fee as the utilization fee (S430). Then, fee setting server 100 transmits, to communication terminal 200, display information for causing communication terminal 200 to display the specified standard fee (S425).

When communication terminal 200 receives the display information from fee setting server 100, communication terminal 200 provides indication based on the display information in display 250 (S220).

When fee setting server 100 determines that application of the multiple occupants discount is desired (YES in S400), fee setting server 100 transmits, to communication terminal 200, image shooting instruction information instructing to shoot an image of an occupant(s) within the vehicle (an image shooting request) (S405).

When communication terminal 200 receives the image shooting instruction information from fee setting server 100 (YES in S200), communication terminal 200 notifies the user to shoot an image within the vehicle. When image shooting is performed by the user, communication terminal 200 transmits, to fee setting server 100, shot image information which is a shot image of the occupant(s) within the vehicle (S210). When communication terminal 200 does not receive the image shooting instruction information (NO in S200), communication terminal 200 proceeds the processing to S215.

Communication terminal 200 determines whether or not it acquires the display information from fee setting server 100 (S215). When communication terminal 200 does not acquire the display information from fee setting server 100 (NO in S215), communication terminal 200 returns the processing to S200. When communication terminal 200 acquires the display information from fee setting server 100 (YES in S215), communication terminal 200 performs the processing in S220.

When fee setting server 100 acquires the shot image information from communication terminal 200, fee setting server 100 specifies the number of occupants when riding in vehicle 300 (at the start of utilization of vehicle 300) using the shot image information, sets it as the number of occupants when riding in the vehicle, and stores it in user list 500 (S410). Fee setting server 100 determines whether or not the set number of occupants when riding in the vehicle is 2 or more (S415). When fee setting server 100 determines that the number of occupants when riding in the vehicle is less than 2, that is, 1 (NO in S415), fee setting server 100 reads discount application list 700 from storage unit 120. Fee setting server 100 checks the determined result against discount application list 700, and specifies the standard fee as the utilization fee (S430). Then, fee setting server 100 transmits, to communication terminal 200, the display information for causing communication terminal 200 to display the specified utilization fee (S425).

When fee setting server 100 determines that the set number of occupants when riding in the vehicle is 2 or more (YES in S415), fee setting server 100 reads discount application list 700 from storage unit 120. Fee setting server 100 checks the determined result against discount application list 700, and specifies a discount rate for the multiple occupants discount depending on the number of occupants when riding in the vehicle (S420). Then, fee setting server 100 transmits, to communication terminal 200, the display information for causing communication terminal 200 to display the specified discount rate (S425).

When communication terminal 200 receives the display information from fee setting server 100 (YES in S215), communication terminal 200 displays the discount rate specified at the start of utilization as a measure in display 250 (S220). Thereby, from the display, the user can recognize the measure of the utilization fee at the start of utilization of vehicle 300, as in the first embodiment.

It should be noted that, although the second embodiment describes an example where communication terminal 200 is caused to display the specified discount rate, vehicle 300 may be caused to display the specified discount rate. In that case, fee setting server 100 transmits the display information to vehicle 300 in S425.

FIG. 9 is a flowchart showing processing at the end of utilization of vehicle 300 performed by fee setting server 100, communication terminal 200, and vehicle 300 in accordance with the second embodiment. This processing is performed each time the user ends utilization of EV car sharing in fee setting system 1.

When end-of-utilization processing is performed, vehicle 300 transmits end-of-utilization information to fee setting server 100 (S550).

When fee setting server 100 acquires the end-of-utilization information, fee setting server 100 refers to user list 500, and determines whether or not application of the multiple occupants discount is desired (S450).

When fee setting server 100 determines that application of the multiple occupants discount is not desired (NO in S450), fee setting server 100 reads discount application list 700 from storage unit 120. Fee setting server 100 checks the determined result against discount application list 700, and sets the standard fee as the utilization fee (S475).

When fee setting server 100 determines that application of the multiple occupants discount is desired (YES in S450), fee setting server 100 transmits, to communication terminal 200, image shooting instruction information instructing to shoot an image of the state within the vehicle (an image shooting request) (S455).

When communication terminal 200 receives the image shooting instruction information from fee setting server 100 (YES in S250), communication terminal 200 shoots an image within the vehicle, and transmits, to fee setting server 100, shot image information which is a shot image of the occupant(s) within the vehicle (S260). When communication terminal 200 does not receive the image shooting instruction information (NO in S250), communication terminal 200 terminates the processing.

When fee setting server 100 acquires the shot image information from communication terminal 200, fee setting server 100 specifies the number of occupants when getting off vehicle 300 (at the end of utilization of vehicle 300) using the shot image information. Fee setting server 100 sets it as the number of occupants when getting off the vehicle, and stores it in user list 500 (S460).

Fee setting server 100 determines whether or not the set number of occupants when getting off vehicle 300 is 2 or more (S465). When fee setting server 100 determines that the number of occupants when getting off vehicle 300 is less than 2, that is, 1 (NO in S465), fee setting server 100 reads discount application list 700 from storage unit 120. Then, fee setting server 100 checks the determined result against discount application list 700, and sets the standard fee as the utilization fee (S475).

When fee setting server 100 determines that the set number of occupants when getting off vehicle 300 is 2 or more (YES in S465), fee setting server 100 reads discount application list 700 from storage unit 120. Fee setting server 100 checks the determined result against discount application list 700, and specifies a discount rate for the multiple occupants discount depending on the number of occupants when getting off vehicle 300 (S470). Then, fee setting server 100 sets the utilization fee by applying the specified discount rate (S475).

As described above, in the second embodiment, fee setting server 100 acquires in-vehicle image data (information of the number of occupants), which is shot image information, from communication terminal 200. Then, fee setting server 100 specifies the number of riding occupants from the acquired in-vehicle image data, and sets it as the number of occupants. In a case where the set number of occupants is large, fee setting server 100 sets the utilization fee to be lower than that in a case where the number of occupants is small.

Thus, the number of occupants can be specified using communication terminal 200 of the user. Even in a case where a vehicle-mounted camera is not mounted in vehicle 300, the present disclosure is applicable without mounting a new vehicle-mounted camera.

Although the embodiments of the present disclosure have been described, it should be understood that the embodiments disclosed herein are illustrative and non-restrictive in every respect. The scope of the present disclosure is defined by the scope of the claims, and is intended to include any modifications within the scope and meaning equivalent to the scope of the claims.

What is claimed is:

1. A fee setting server configured to set a utilization fee for car sharing, the fee setting server comprising:
an information acquisition unit configured to acquire information of a number of occupants riding in a vehicle utilized for the car sharing; and
a fee setting unit configured to set the utilization fee in a case where a number of occupants specified using the information of the number of occupants at a predetermined time point is large, to be lower than that in a case where the specified number of occupants is small.

2. The fee setting server according to claim 1, wherein the predetermined time point is at end of utilization of the vehicle.

3. The fee setting server according to claim 1, wherein, when a number of occupants at start of utilization of the vehicle is different from a number of occupants at end of utilization of the vehicle, the fee setting unit is configured to set the utilization fee using the number of occupants at the end of utilization of the vehicle.

4. The fee setting server according to claim 1, wherein the vehicle is an electric vehicle.

5. The fee setting server according to claim 1, wherein the information of the number of occupants is a shot image of an occupant(s) in the vehicle.

6. A method for setting a utilization fee for car sharing, the method comprising:
acquiring information of a number of occupants riding in a vehicle utilized for the car sharing; and
setting the utilization fee in a case where a number of occupants specified using the information of the number of occupants at a predetermined time point is large, to be lower than that in a case where the specified number of occupants specified is small.

7. A fee setting system comprising:
a vehicle utilized for car sharing; and
a fee setting server configured to set a utilization fee for the car sharing,
the fee setting server being configured to
acquire information of a number of occupants riding in the vehicle, and
set the utilization fee in a case where a number of occupants specified using the information of the number of occupants at a predetermined time point is large, to be lower than that in a case where the specified number of occupants is small.

8. The fee setting system according to claim 7, wherein the fee setting server is configured to acquire the information of the number of occupants from the vehicle.

9. The fee setting system according to claim 7, further comprising a communication terminal configured to communicate with the fee setting server, wherein
the fee setting server acquires the information of the number of occupants from the communication terminal.
